(19) United States
(12) Patent Application Publication
(10) Pub. No.: US 2024/0381041 A1
(43) Pub. Date: Nov. 14, 2024

(54) PIEZOELECTRIC ACTUATOR WITH SLIDABLE COUPLER

(71) Applicant: Cochlear Limited, Macquarie University, NSW (AU)

(72) Inventors: Henrik FYRLUND, Mölnlycke (SE); Luke POGGI, Gothenburg (SE); Tommy BERGS, Härryda (SE)

(21) Appl. No.: 18/685,046

(22) PCT Filed: Sep. 7, 2022
(86) PCT No.: PCT/IB2022/058432

§ 371 Date: Feb. 20, 2024

Related U.S. Application Data
(60) Provisional application No. 63/249,807, filed on Sep. 29, 2021.

(51) Int. Cl. H04R 25/00; H04R 17/00

(52) U.S. Cl. CPC H04R 25/606; H04R 17/00; H04R 2225/67

(57) ABSTRACT

An actuator for generating vibrations is configured to be in mechanical communication with a fixture implanted on or within a recipient's body and includes a piezoelectric oscillator configured to undergo bending oscillations in response to received electric voltage signals and at least one mass configured to move in response to the bending oscillations of the piezoelectric oscillator. The actuator further includes at least one resilient coupler mechanically attached to the piezoelectric oscillator and configured to, in response to an impulse applied to the actuator, allow movement of the piezoelectric oscillator relative to the fixture and/or of the at least one mass relative to the piezoelectric oscillator.

### BACKGROUND

### Field

The present application relates generally to an implantable actuator for generating vibrations, and more specifically, to implantable auditory prostheses for generating auditory vibrations.

### Description of the Related Art

Medical devices have provided a wide range of therapeutic benefits to recipients over recent decades. Medical devices can include internal or implantable components/devices, external or wearable components/devices, or combinations thereof (e.g., a device having an external component communicating with an implantable component). Medical devices, such as traditional hearing aids, partially or fully-implantable hearing prostheses (e.g., bone conduction devices, mechanical stimulators, cochlear implants, etc.), pacemakers, defibrillators, functional electrical stimulation devices, and other medical devices, have been successful in performing lifesaving and/or lifestyle enhancement functions and/or recipient monitoring for a number of years.

The types of medical devices and the ranges of functions performed thereby have increased over the years. For example, many medical devices, sometimes referred to as “implantable medical devices,” now often include one or more instruments, apparatus, sensors, processors, controllers or other functional mechanical or electrical components that are permanently or temporarily implanted in a recipient. These functional devices are typically used to diagnose, prevent, monitor, treat, or manage a disease/injury or symptom thereof, or to investigate, replace or modify the anatomy or a physiological process. Many of these functional devices utilize power and/or data received from external devices that are part of, or operate in conjunction with, implantable components.

### SUMMARY

In one aspect disclosed herein, an apparatus comprises an actuator configured to generate vibrations. The actuator comprises a coupling portion configured to be in mechanical communication with a fixture implanted on or within a recipient's body. The coupling portion extends from the fixture along a longitudinal axis. The actuator further comprises a piezoelectric oscillator having a first portion in mechanical communication with the coupling portion and a second portion spaced from the coupling portion. The piezoelectric oscillator is configured to undergo bending oscillations in response to received electric voltage signals. The actuator further comprises at least one mass in mechanical communication with the second portion. The at least one mass is configured to move in response to the bending oscillations of the piezoelectric oscillator. The actuator further comprises at least one resilient coupler mechanically attached to the coupling portion and to the first portion and/or mechanically attached to the second portion and to the at least one mass. The at least one resilient coupler is configured to, in response to an impulse applied to the actuator, allow movement of the first portion relative to the coupling portion and/or of the at least one mass relative to the second portion, the movement substantially parallel to the longitudinal axis.

In another aspect disclosed herein, a method comprises applying oscillating electric voltage signals to a piezoelectric element mechanically coupled to a rigid portion by a first coupler and to at least one mass by a second coupler. At least one of the first coupler and the second coupler comprises a resilient member. The piezoelectric element responds to the electric voltage signals by imparting oscillatory motion to the at least one mass relative to the rigid portion. The method further comprises, in response to an impulse greater than a predetermined threshold value applied to at least one of the coupling portion, the piezoelectric element, and the at least one mass. The response to the impulse comprises causing a first relative movement between the piezoelectric element and the rigid portion and/or between the piezoelectric element and the at least one mass, the first relative movement in a first direction. The response to the impulse further comprises, in response to the relative movement, resiliently deforming the at least one resilient member to apply at least one restoring force to at least one of the coupling portion, the piezoelectric element, and the at least one mass. The response to the impulse further comprises, in response to the at least one restoring force, causing a second relative movement between the piezoelectric element and the rigid portion and/or between the piezoelectric element and the at least one mass, the second relative movement in a second direction substantially opposite to the first direction.

In another aspect disclosed herein, an apparatus comprises an auditory prosthesis configured to generate and transmit vibrations to a recipient's body such that the vibrations evoke a hearing percept by the recipient. The auditory prosthesis comprises an elongate structure configured to be in mechanical communication with a bone fixture implanted on or within a recipient's body. The auditory prosthesis further comprises a piezoelectric oscillator in mechanical communication with the elongate structure. The piezoelectric oscillator is configured to undergo bending oscillations in response to received electric voltage signals. The auditory prosthesis further comprises at least one counterweight in mechanical communication with the piezoelectric oscillator. The at least one counterweight is configured to move in response to the bending oscillations of the piezoelectric oscillator. The auditory prosthesis further comprises at least one coupler comprising a resilient spring or material. The at least one coupler mechanically couples the elongate structure with the piezoelectric oscillator and/or mechanically couples the piezoelectric oscillator with the at least one counterweight. The at least one coupler is at a first position relative to the elongate structure and is configured to move to at least one second position relative to the elongate structure in response to an external force applied to the auditory prosthesis greater than a predetermined threshold value. The at least one coupler is further configured to then return to the first position upon absence of the external force.

### BRIEF DESCRIPTION OF THE DRAWINGS

Implementations are described herein in conjunction with the accompanying drawings, in which:

FIG. 1A schematically illustrates a portion of an example transcutaneous bone conduction device implanted in a recipient in accordance with certain implementations described herein;

FIG. 1B schematically illustrate a portion of another example transcutaneous bone conduction device implanted in a recipient in accordance with certain implementations described herein;

FIG. 1C depicts a side view of a portion of an example percutaneous bone conduction device in accordance with certain implementations described herein;

FIGS. 2A and 2B schematically illustrate side cross-sectional views of two example apparatuses in accordance with certain implementations described herein;

FIG. 3 schematically illustrates an example resilient element comprising a garter spring compatible with certain implementations described herein;

FIG. 4A-4B schematically illustrate cross-sectional views of two configurations of an example resilient coupler comprising a resilient element in accordance with certain implementations described herein;

FIGS. 5A-5B schematically illustrate cross-sectional views of portions of two example resilient couplers in accordance with certain implementations described herein;

FIG. 6A schematically illustrates a top view of an example actuator comprising a resilient coupler that releasably couples the piezoelectric element with the at least one mass in accordance with certain implementations described herein;

FIG. 6B schematically illustrates a cross-sectional view of a portion of the example actuator 410 of FIG. 6A;

FIG. 6C schematically illustrates a cross-sectional view of a portion of another example actuator comprising a resilient coupler that releasably couples the piezoelectric element with the at least one mass in accordance with certain implementations described herein;

FIGS. 7A and 7B schematically illustrate cross-sectional views of two example actuators in which the resilient element of the at least one resilient coupler comprises a spring in accordance with certain implementations described herein; and

FIG. 8 is a flow diagram of an example method in accordance with certain implementations described herein.

### DETAILED DESCRIPTION

For an actuator comprising a piezoelectric oscillator that is rigidly affixed to both a center post and counterweights spaced from the center post, external forces (e.g., impulses from shocks or impacts) applied to the actuator can subject the piezoelectric oscillator to stresses (e.g., due to inertia of the suspended counterweight, either during the initial impulse or during the rebound counterweight movement upon deceleration of the other portions of the actuator). These stresses risk breaking the piezoelectric oscillator and disabling the actuator. While one solution can be to restrict the gap between the counterweight and the chassis (e.g., to be about 10 microns) so as to limit the maximum deflection of the counterweight to be less than the breaking point of the piezoelectric oscillator, such small gaps can be challenging in production (e.g., the tolerances of such small gaps can be difficult to produce).

Certain implementations described herein provide an actuator with at least one releasable coupler between the center post and the counterweight. For example, a releasable coupler (e.g., spring; garter spring; radial spring; O-ring) can be between the center post and the piezoelectric oscillator and/or between the piezoelectric oscillator and the counterweight. The releasable coupler can form a suspended center point at which the coupling effectively floats. When the actuator housing is subjected to a sufficiently strong external force, the housing moves and inertia (e.g., primarily from the counterweight) allows the coupled portions to temporarily partially decouple from one another, thereby avoiding damaging stresses to the piezoelectric oscillator. The at least one releasable coupler can further produce a restoring force that reestablishes the coupling for continued operation. The actuator of certain implementations described herein has an increased tolerance to impulses from shocks or impacts than do other actuators. By tailoring the mechanical coupling between the center post and the piezoelectric/counterweight assembly, the actuator of certain implementations described herein allow for controllable tuning of the resonance frequency and vibrational frequency spectrum of the actuator. By virtue of being snap-coupled onto the center post, the actuator of certain implementations described herein allows for pre-mounting testing of the piezoelectric/counterweight assembly (e.g., on a test interface or skull simulator) and once the assembly is approved for use, the assembly can be removed and placed onto the actual implantable device), resulting in improved yield as compared to assemblies which can only be operated once welded onto a center post.

The teachings detailed herein are applicable, in at least some implementations, to any type of implantable medical device (e.g., implantable vibration stimulation system or device; bone conduction auditory prosthesis) comprising a first portion implanted on or within the recipient's body and configured to provide vibrations to a portion of the recipient's body. Implementations can include any type of medical device that can utilize the teachings detailed herein and/or variations thereof (e.g., medical devices that comprise at least one implantable or external fragile element to be protected from excessive stresses and/or strains). Furthermore, while certain implementations are described herein in the context of implantable auditory prosthesis devices, certain other implementations are compatible in the context of other implantable or non-implantable devices or systems (e.g., bone conduction headphones; bone conduction speakers; bone conduction microphones; ultrasonic imaging).

Merely for ease of description, apparatus and methods disclosed herein are primarily described with reference to an illustrative medical device, namely an active transcutaneous or percutaneous bone conduction auditory prosthesis systems. However, the teachings detailed herein and/or variations thereof may also be used with a variety of other medical or non-medical systems that provide a wide range of therapeutic benefits to recipients, patients, or other users. In some implementations, the teachings detailed herein and/or variations thereof can be utilized in other types of devices beyond auditory prostheses that may benefit from a vibration-generating actuator able to fit within a region having restricted space and/or improved control of piezoelectric vibrations (e.g., a direction of vibration motion). Implementations can include any type of auditory prosthesis that can utilize the teachings detailed herein and/or variations thereof. Certain such implementations can be referred to as “partially implantable,” “semi-implantable,” “mostly implantable,” “fully implantable,” or “totally implantable” auditory prostheses. In some implementations, the teachings detailed herein and/or variations thereof can be utilized in other types of prostheses beyond auditory prostheses.

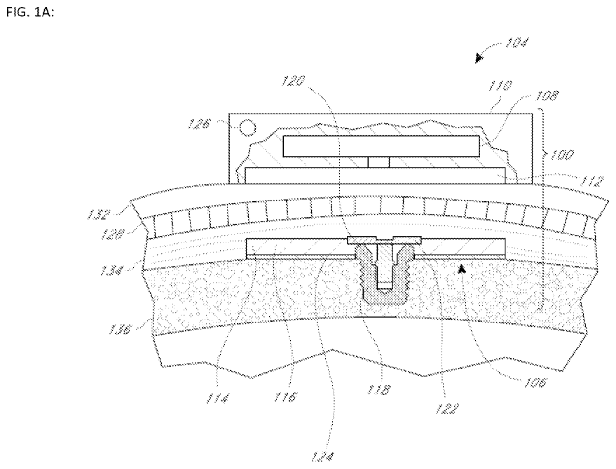

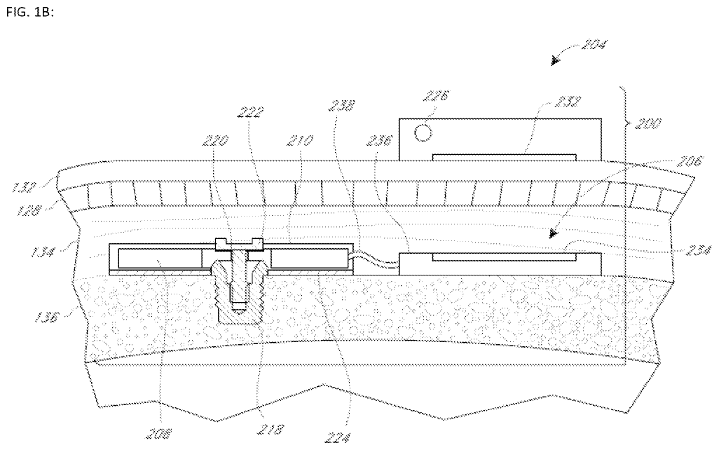

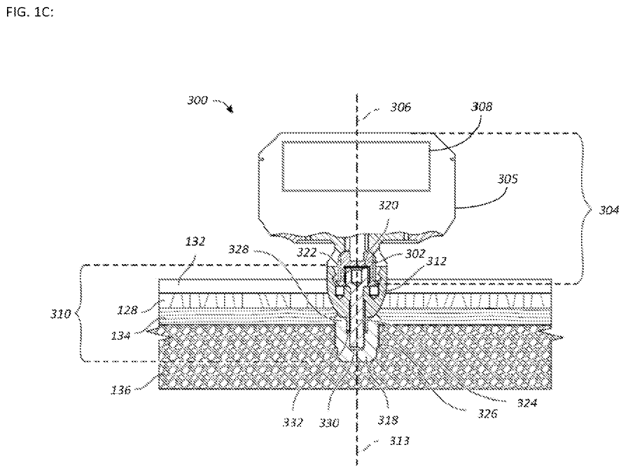

FIG. 1A schematically illustrates a portion of an example transcutaneous bone conduction device 100 implanted in a recipient in accordance with certain implementations described herein. FIG. 1B schematically illustrate a portion of another example transcutaneous bone conduction device 200 implanted in a recipient in accordance with certain implementations described herein. FIG. 1C schematically illustrates a side view of a portion of an example percutaneous bone conduction device 300 in accordance with certain implementations described herein.

The example transcutaneous bone conduction device 100 of FIG. 1A includes an external device 104 and an implantable component 106. The transcutaneous bone conduction device 100 of FIG. 1A is a passive transcutaneous bone conduction device in that a vibrating actuator 108 is located in the external device 104 and delivers vibrational stimuli through the skin 132 to the skull 136. The vibrating actuator 108 is located in a housing 110 of the external component 104 and is coupled to a plate 112. The plate 112 can be in the form of a permanent magnet and/or in another form that generates and/or is reactive to a magnetic field, or otherwise permits the establishment of magnetic attraction between the external device 104 and the implantable component 106 sufficient to hold the external device 104 against the skin 132 of the recipient.

In certain implementations, the vibrating actuator 108 is a device that converts electrical signals into vibration. In operation, a sound input element 126 can convert sound into electrical signals. Specifically, the transcutaneous bone conduction device 100 can provide these electrical signals to the vibrating actuator 108, or to a sound processor (not shown) that processes the electrical signals, and then provides those processed signals to the vibrating actuator 108. The vibrating actuator 108 can convert the electrical signals (processed or unprocessed) into vibrations. Because the vibrating actuator 108 is mechanically coupled to the plate 112, the vibrations are transferred from the vibrating actuator 108 to the plate 112. The implanted plate assembly 114 is part of the implantable component 106, and is made of a ferromagnetic material that may be in the form of a permanent magnet, that generates and/or is reactive to a magnetic field, or otherwise permits the establishment of a magnetic attraction between the external device 104 and the implantable component 106 sufficient to hold the external device 104 against the skin 132 of the recipient. Accordingly, vibrations produced by the vibrating actuator 108 of the external device 104 are transferred from the plate 112 across the skin 132 to a plate 116 of the plate assembly 114. This can be accomplished as a result of mechanical conduction of the vibrations through the skin 132, resulting from the external device 104 being in direct contact with the skin 132 and/or from the magnetic field between the two plates 112, 116. These vibrations are transferred without a component penetrating the skin 132, fat 128, or muscular 134 layers on the head.

In certain implementations, the implanted plate assembly 114 is substantially rigidly attached to a bone fixture 118. The implantable plate assembly 114 can include a through hole 120 that is contoured to the outer contours of the bone fixture 118. This through hole 120 thus forms a bone fixture interface section that is contoured to the exposed section of the bone fixture 118. In certain implementations, the sections are sized and dimensioned such that at least a slip fit or an interference fit exists with respect to the sections. A screw 122 can be used to secure the plate assembly 114 to the bone fixture 118. In certain implementations, a silicone layer 124 is located between the plate 116 and the bone 136 of the skull.

As can be seen in FIG. 1A, the head of the screw 122 is larger than the hole through the implantable plate assembly 114, and thus the screw 122 positively retains the implantable plate assembly 114 to the bone fixture 118. The portions of the screw 122 that interface with the bone fixture 118 substantially correspond to an abutment screw, thus permitting the screw 122 to readily fit into an existing bone fixture used in a percutaneous bone conduction device. In certain implementations, the screw 122 is configured so that the same tools and procedures that are used to install and/or remove an abutment screw from the bone fixture 118 can be used to install and/or remove the screw 122 from the bone fixture 118.

As schematically illustrated by FIG. 1B, an example transcutaneous bone conduction device 200 comprises an external device 204 and an implantable component 206. The device 200 is an active transcutaneous bone conduction device in that the vibrating actuator 208 is located in the implantable component 206. For example, a vibratory element in the form of a vibrating actuator 208 is located in a housing 210 of the implantable component 206. In certain implementations, much like the vibrating actuator 108 described herein with respect to the transcutaneous bone conduction device 100, the vibrating actuator 208 is a device that converts electrical signals into vibration. The vibrating actuator 208 can be in direct contact with the outer surface of the recipient's skull 136 (e.g., the vibrating actuator 208 is in substantial contact with the recipient's bone 136 such that vibration forces from the vibrating actuator 208 are communicated from the vibrating actuator 208 to the recipient's bone 136). In certain implementations, there can be one or more thin non-bone tissue layers (e.g., a silicone layer 224) between the vibrating actuator 208 and the recipient's bone 136 (e.g., bone tissue) while still permitting sufficient support so as to allow efficient communication of the vibration forces generated by the vibrating actuator 208 to the recipient's bone 136.

In certain implementations, the external component 204 includes a sound input element 226 that converts sound into electrical signals. Specifically, the device 200 provides these electrical signals to the vibrating actuator 208, or to a sound processor (not shown) that processes the electrical signals, and then provides those processed signals to the implantable component 206 through the skin of the recipient via a magnetic inductance link. For example, a communication coil 232 of the external component 204 can transmit these signals to an implanted communication coil 234 located in a housing 236 of the implantable component 206. Components (not shown) in the housing 236, such as, for example, a signal generator or an implanted sound processor, then generate electrical signals to be delivered to the vibrating actuator 208 via electrical lead assembly 238. The vibrating actuator 208 converts the electrical signals into vibrations. In certain implementations, the vibrating actuator 208 can be positioned with such proximity to the housing 236 that the electrical leads 238 are not present (e.g., the housing 210 and the housing 236 are the same single housing containing the vibrating actuator 208, the communication coil 234, and other components, such as, for example, a signal generator or a sound processor).

In certain implementations, the vibrating actuator 208 is mechanically coupled to the housing 210. The housing 210 and the vibrating actuator 208 collectively form a vibrating element. The housing 210 can be substantially rigidly attached to a bone fixture 218. In this regard, the housing 210 can include a through hole that is contoured to the outer contours of the bone fixture 218. The screw 222 can be used to secure the housing 210 to the bone fixture 218. As can be seen in FIG. 1B, the head of the screw 222 is larger than the through hole of the housing 210, and thus the screw 222 positively retains the housing 210 to the bone fixture 218. The portions of the screw 222 that interface with the bone fixture 218 substantially correspond to the abutment screw detailed below, thus permitting the screw 222 to readily fit into an existing bone fixture used in a percutaneous bone conduction device (or an existing passive bone conduction device). In certain implementations, the screw 222 is configured so that the same tools and procedures that are used to install and/or remove an abutment screw from the bone fixture 218 can be used to install and/or remove the screw 222 from the bone fixture 218.

The example transcutaneous bone conduction auditory device 100 of FIG. 1A comprises an external sound input element 126 (e.g., external microphone) and the example transcutaneous bone conduction auditory device 200 of FIG. 1B comprises an external sound input element 226 (e.g., external microphone). Other example auditory devices (e.g., totally implantable transcutaneous bone conduction devices) in accordance with certain implementations described herein can replace the external sound input element 126, 226 with a subcutaneously implantable sound input assembly (e.g., implanted microphone).

In certain implementations, the example percutaneous bone conduction device 300 comprises an operationally removable component 304 and a bone conduction implant 310, as schematically illustrated by FIG. 1C. The operationally removable component 304 comprises a housing 305 and is operationally releasably coupled to the bone conduction implant 310. By operationally releasably coupled, it is meant that it is releasable in such a manner that the recipient can relatively easily attach and remove the operationally removable component 304 during normal use of the percutaneous bone conduction device 300, repeatedly if desired. Such releasable coupling is accomplished via a coupling apparatus 302 of the operationally removable component 304 and a corresponding mating apparatus (e.g., abutment 312) of the bone conduction implant 310, as will be detailed below. This operationally releasable coupling is contrasted with how the bone conduction implant 310 is attached to the skull, as will also be detailed below.

The operationally removable component 304 of certain implementations includes a sound input element (e.g., a microphone; a cable or wireless connection configured to receive signals indicative of sound from an audiovisual device), a sound processor (e.g., sound processing circuitry, control electronics, actuator drive components, power module) configured to generate control signals in response to electrical signals from the sound input element, and at least one vibrating actuator 308 configured to generate acoustic vibrations in response to the control signals. The at least one vibrating actuator 308 can comprise a vibrating electromagnetic actuator, a vibrating piezoelectric actuator, and/or another type of vibrating actuator, and the operationally removable component 304 is sometimes referred to herein as a vibrator unit. The control signals are configured to cause the at least one vibrating actuator 308 to vibrate, generating a mechanical output force in the form of acoustic vibrations that is delivered to the skull of the recipient via the bone conduction implant 310. In other words, the operationally removable component 304 converts received sound signals into mechanical motion using the at least one vibrating actuator 308 to impart vibrations to the recipient's skull which are detected by the recipient's ossicles and/or cochlea. In certain implementations, the operationally removable component 304 comprises a single housing 305, as schematically illustrated by FIG. 1C, while in certain other implementations, the operationally removable component 304 comprises a plurality of housings (e.g., separate or different housings, which can have wired and/or wireless connections therebetween).

As schematically illustrated in FIG. 1C, the operationally removable component 304 further includes a coupling apparatus 302 configured to operationally removably attach the operationally removable component 304 to a bone conduction implant 310 (also referred to as an anchor system and/or a fixation system) which is implanted in the recipient. The coupling apparatus 302 can be configured to be repeatedly coupled to and decoupled from the bone conduction implant 310. The coupling apparatus 302 comprises a longitudinal axis 306 (e.g., an axis along a length of the coupling apparatus 302; an axis about which the coupling apparatus 302 is at least partially symmetric). The at least one vibrating actuator 308 of the operationally removable component 304 is in vibrational communication with the coupling apparatus 302 such that vibrations generated by the at least one vibrating actuator 308 are transmitted to the coupling apparatus 302 and then to the bone conduction implant 310 in a manner that at least effectively evokes a hearing percept.

The example bone conduction implant 310 of FIG. 1C comprises a percutaneous abutment 312, a bone fixture 318 (hereinafter sometimes referred to as the fixture 318), and an abutment screw 320. While FIG. 1C illustrates one example bone conduction implant 310 in accordance with certain implementations described herein, other bone conduction implants 310 (e.g., comprising abutments 312, fixtures 318, and/or abutment screws 320 of any type, size/having any geometry) are also compatible with certain implementations described herein.

In certain implementations, the coupling apparatus 302 is configured to be removably attached to the bone conduction implant 310 by pressing the coupling apparatus 302 against the abutment 312 in a direction along (e.g., substantially parallel to) the longitudinal axis 306 of the coupling apparatus 302 and/or along (e.g., substantially parallel to) the longitudinal axis 313 of the abutment 312. In certain such implementations, the coupling apparatus 302 can be configured to be snap-coupled (e.g., press-fitted) to the abutment 312. In certain implementations, as depicted by FIG. 1C, the coupling apparatus 302 comprises a male component and the abutment 312 comprises a female component configured to mate with the male component of the coupling apparatus 302. In certain implementations, this configuration can be reversed, with the coupling apparatus 302 comprises a female component and the abutment 312 comprises a male component configured to mate with the female component of the coupling apparatus 302.

The abutment 312 of certain implementations is symmetrical with respect to at least those portions of the abutment 312 above the top portion of the fixture 318. For example, the exterior surfaces of the abutment 312 can form concentric outer profiles about a longitudinal axis 313 of the abutment 312 (e.g., an axis along a length of the abutment 312; an axis about which the abutment 312 is at least partially symmetric). As shown in FIG. 1C, the exterior surfaces of the abutment 312 establish diameters lying on planes normal to the longitudinal axis 313 that vary along the length of the longitudinal axis 313. For example, the abutment 312 can include outer diameters that progressively become larger with increased distance from the fixture 318. In certain other implementations, the outer diameters can have other outer profiles.

In certain implementations, the abutment 312 is configured for integration between the skin and the abutment 312. Integration between the skin and the abutment 312 can be considered to occur when the soft tissue of the skin 132 encapsulates the abutment 312 in fibrous tissue and does not readily dissociate itself from the abutment 312, which can inhibit the entrapment and/or growth of microbes proximate the bone conduction implant 310. For example, the abutment 312 can have a surface having features which are configured to reduce certain adverse skin reactions. In certain implementations, the abutment 312 is coated to reduce the shear modulus, which can also encourage skin integration with the abutment 213. For example, at least a portion of the abutment 312 can be coated with or otherwise contain a layer of hydroxyapatite that enhances the integration of skin with the abutment 312.

In certain implementations, the abutment 312 is configured to be attached to the fixture 318 via the abutment screw 320, and the fixture 318 is configured to be fixed to (e.g., screwed into) the recipient's skull bone 136. The abutment 312 extends from the fixture 318, through muscle 134, fat 128, and skin 132 so that the coupling apparatus 140 can be attached thereto. The abutment screw 320 (e.g., comprising a screw head 322 and an elongate coupling shaft 324 connected to the screw head 322) connects and holds the abutment 312 to the fixture 318, thereby rigidly attaching the abutment 312 to the fixture 318. The rigid attachment is such that the abutment 312 is vibrationally connected to the fixture 318 such that at least some of the vibrational energy transmitted to the abutment 312 is transmitted to the fixture 318 in a sufficient manner to effectively evoke a hearing percept (e.g., to mechanically vibrate the skull bone of the recipient, the vibrations received by the recipient's cochlea to compensate for conductive hearing loss, mixed hearing loss, or single-sided deafness). The percutaneous abutment 312 provides an attachment location for the coupling apparatus 302 that facilitates efficient transmission of mechanical force.

The fixture 318 can be made of any material that has a known ability to integrate into surrounding bone tissue (e.g., comprising a material that exhibits acceptable osseointegration characteristics). In certain implementations, the fixture 318 is formed from a single piece of material (e.g., titanium) and comprises outer screw threads 326 forming a male screw which is configured to be installed into the skull bone 136 and a flange 328 configured to function as a stop when the fixture 318 is implanted into the skull bone 136. The screw threads 326 can have a maximum diameter of about 3.5 mm to about 5.0 mm, and the flange 328 can have a diameter which exceeds the maximum diameter of the screw threads 326 (e.g., by approximately 10%-20%). The flange 328 can have a planar bottom surface for resting against the outer bone surface, when the fixture 318 has been screwed down into the skull bone 136. The flange 328 prevents the fixture 318 (e.g., the screw threads 326) from potentially completely penetrating completely through the bone 136.

The body of the fixture 318 can have a length sufficient to securely anchor the fixture 318 to the skull bone 136 without penetrating entirely through the skull bone 136. The length of the body can therefore depend on the thickness of the skull bone 136 at the implantation site. For example, the fixture 318 can have a length, measured from the planar bottom surface of the flange 328 to the end of the distal region (e.g., the portion farthest from the flange 328), that is no greater than 5 mm or between about 3.0 mm to about 5.0 mm, which limits and/or prevents the possibility that the fixture 318 might go completely through the skull bond 136.

The interior of the fixture 318 can further include an inner lower bore 330 having female screw threads configured to mate with male screw threads of the elongate coupling shaft 324 to secure the abutment screw 320 and the abutment 312 to the fixture 318. The fixture 318 can further include an inner upper bore 332 that receives a bottom portion of the abutment 312. While FIG. 1C shows the coupling apparatus 302 directly engaging with (e.g., directly contacting) the abutment screw 320 (e.g., the screw head 322), in certain other implementations, the coupling apparatus 302 engages with the abutment 312 without directly engaging with (e.g., without directly contacting) the abutment screw 320.

In certain implementations, the bottom of the abutment 312 includes a fixture connection section extending below a reference plane extending across the top of the fixture 318 and that interfaces with the fixture 318. Upon sufficient tensioning of the abutment screw 320, the abutment 312 sufficiently elastically and/or plastically stresses the fixture 318, and/or visa-versa, so as to form a tight seal at the interface of surfaces of the abutment 312 and the fixture 318. Certain such implementations can reduce (e.g., eliminate) the chances of micro-leakage of microbes into the gaps between the abutment 312, the fixture 318 and the abutment screw 320.

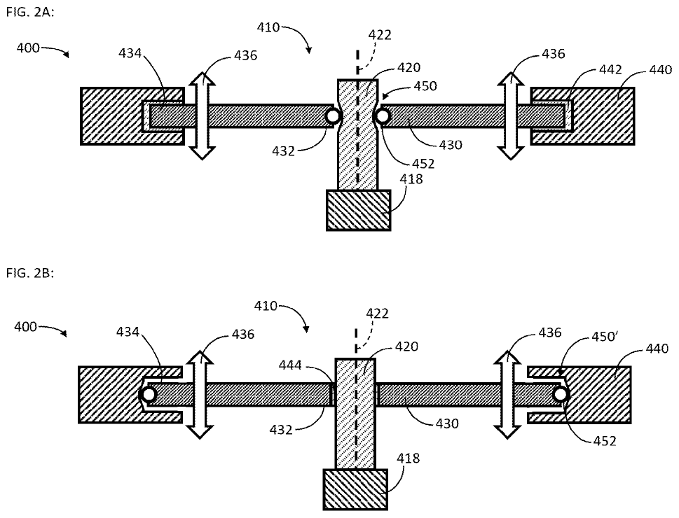

FIGS. 2A and 2B schematically illustrate side cross-sectional views of two example apparatuses 400 in accordance with certain implementations described herein. For example, each of the example apparatuses 400 of FIGS. 2A and 2B can be an external component 104 of a passive transcutaneous bone conduction device 100 as schematically illustrated in FIG. 1A, an implantable component 206 of an active transcutaneous bone conduction device 200 as schematically illustrated in FIG. 1B, or an operationally removable component 304 of a percutaneous bone conduction device 300 as schematically illustrated in FIG. 1C.

Each of the example apparatuses 400 of FIGS. 2A and 2B comprises an actuator 410 configured to generate vibrations. The actuator 410 comprises a coupling portion 420 configured to be in mechanical communication with a fixture 418 (e.g., bone fixture 118, 218, 318) implanted on or within a recipient's body. The coupling portion 420 extends from the fixture 418 along a longitudinal axis 422. The actuator 410 further comprises a piezoelectric oscillator 430 having a first portion 432 in mechanical communication with the coupling portion 420 and a second portion 434 spaced from the coupling portion 420. The piezoelectric oscillator 430 is configured to undergo bending oscillations 436 in response to received electric voltage signals. The actuator 410 further comprises at least one mass 440 in mechanical communication with the second portion 434. The at least one mass 440 is configured to move in response to the bending oscillations 436 of the piezoelectric oscillator 430.

As schematically illustrated by FIG. 2A, the actuator 410 comprises at least one resilient (e.g., elastically compressible; flexible) coupler 450 mechanically attached to the coupling portion 420 and to the first portion 432 of the piezoelectric oscillator 430. The at least one resilient coupler 450 is configured to, in response to an impulse (e.g., sudden force; mechanical shock) applied to the actuator 410, allow relative movement between the first portion 432 and the coupling portion 420 (e.g., movement of the first portion 432 while the coupling portion 420 does not move; or vice versa), the movement substantially parallel to the longitudinal axis 422. As schematically illustrated by FIG. 2B, the actuator 410 comprises at least one resilient coupler 450′ mechanically attached to the second portion 434 of the piezoelectric oscillator 430 and to the at least one mass 440 (e.g., movement of the at least one mass 440 while the second portion 434 does not move; or vice versa). The at least one resilient coupler 450′ is configured to, in response to an impulse (e.g., sudden force; mechanical shock) applied to the actuator 410, allow relative movement between the at least one mass 440 and the second portion 434, the movement substantially parallel to the longitudinal axis 422.

In certain implementations, the actuator 410 is a vibrating actuator 108 within a housing 110 external to the recipient's body, and the coupling portion 420 comprises at least one elongate structure (e.g., cylindrical element; post; screw) affixed to a plate 112 (e.g., permanent magnet and/or other ferromagnetic or ferrimagnetic element) that is magnetically attracted to a corresponding implanted plate assembly 114 substantially rigidly attached to a bone fixture 118. In certain other implementations, the actuator 410 is a vibrating actuator 208 within a housing 210 implanted on or within the recipient's body, and the coupling portion 420 comprises at least one elongate structure 220 (e.g., cylindrical element; post; screw 222) affixed to a bone fixture 218 (e.g., via a clamp, screw, adhesive, or other coupler). In certain other implementations, the actuator 410 is a vibrating actuator 308 within an external housing 305 having a coupling apparatus 302 that is configured to mate with an abutment 312 of the bone conduction implant 310, and the coupling portion 420 comprises at least one elongate structure (e.g., cylindrical element; post; screw) in mechanical communication with the bone fixture 318 via the coupling apparatus 302 and the abutment 312.

In certain implementations, the housing 110, 210, 305 is configured to hermetically seal the piezoelectric oscillator 430, the at least one mass 440, and the at least one resilient coupler 450, 450′ from an environment surrounding the actuator 410. The housing 110, 210, 305 can have a length and/or a width less than or equal to 40 millimeters (e.g., in a range of 15 millimeters to 35 millimeters; in a range of 25 millimeters to 35 millimeters; in a range of less than 30 millimeters; in a range of 15 millimeters to 30 millimeters), and/or a thickness less than or equal to 7 millimeters (e.g., in a range of less than or equal to 6 millimeters, in a range of less than or equal to 5 millimeters; in a range of less than or equal to 4 millimeters). The housing 110, 210, 305 of certain implementations comprises at least one biocompatible material (e.g., plastic; PEEK; silicone; ceramic; zirconium oxide).

In certain implementations, the actuator 410 is configured to generate vibrational energy (e.g., vibrations) within a range of vibrational frequencies that are perceptible by the recipient as sound (e.g., a range of 20 Hz to 20 kHz), which are referred to herein as auditory vibrations. The coupling portion 420 is part of a propagation path for the auditory vibrations to be transmitted to the fixture (e.g., bone fixture 118, 218, 318) and to propagate via bone conduction from the fixture to an inner ear region (e.g., within the temporal bone and comprising the vestibule, the cochlea, and the semicircular canals) and/or a middle ear region (e.g., within the recipient's head, partially bounded by the tympanic membrane and comprising the ossicles, the round window, the oval window, and the Eustachian tube) to be detected as sound.

In certain implementations, the piezoelectric oscillator 430 comprises a unitary (e.g., single; monolithic) component comprising at least one piezoelectric material. The piezoelectric oscillator 430 of certain implementations comprises two or more layers in mechanical communication with one another (e.g., bonded together) into a unitary component (e.g., a stack), at least one of the layers comprising at least one piezoelectric material (e.g., unimorph having one piezoelectric layer and a non-piezoelectric layer; bimorph having two or more piezoelectric layers). The unitary component can comprise other non-piezoelectric materials, such as a bonding material (e.g., adhesive; epoxy; metal) between piezoelectric layers, electrically conductive material (e.g., metal) configured to apply electrical voltage signals to the at least one piezoelectric material, and/or a non-piezoelectric layer (e.g., metal backplate) affixed to the at least one piezoelectric material. In certain implementations, the number of layers of the piezoelectric oscillator 430 are selected to provide a predetermined power, size (e.g., area, thickness), stiffness, and/or resonance frequency. Examples of piezoelectric materials compatible with certain implementations described herein include but are not limited to: quartz; gallium orthophosphate; langasite; barium titanate; lead titanate; lead zirconate titanate (PZT); potassium niobate; lithium niobate; lithium tantalate; sodium tungstate; sodium potassium niobate; bismuth ferrite; sodium niobate; polyvinylidene fluoride; macro fiber composite (MFC); other piezoelectric crystals, ceramics, or polymers.

In certain implementations, the piezoelectric oscillator 430 is substantially planar (e.g., plate; sheet; disc-shaped) extending along a plane substantially perpendicular to the longitudinal axis 422. For example, the piezoelectric oscillator 430 can be a generally rectangular plate or a generally circular disk. Other planar shapes are also compatible with certain implementations described herein (e.g., oval; polygonal with 5, 6, 7, 8, or more sides; geometric; non-geometric; regular; irregular). In certain implementations, the piezoelectric oscillator 430 has a length (e.g., in a range of 2 millimeters to 20 millimeters), a width substantially perpendicular to the length (e.g., in a range of 2 millimeters to 20 millimeters), and a thickness substantially perpendicular to the length and to the width (e.g., in a range of less than 2 millimeters; less than 1 millimeter; greater than 300 microns). Various configurations and geometries of the piezoelectric oscillator 430 are compatible with certain implementations described herein (see, e.g., “Piezoelectric Ceramic Products: Fundamentals, Characteristics and Applications,” Physik Instruments (PI) GmbH & Co., Lederhose, Germany, www.piceramic.com, (2016)).

In certain implementations, as schematically illustrated by FIG. 2A, the central portion 432 of the piezoelectric oscillator 430 is mechanically coupled to the coupling portion 420 by the at least one resilient coupler 450 and the central portion 432 does not substantially move relative to the coupling portion 420 during the bending oscillations 436 of the piezoelectric oscillator 430. For example, the central region 432 can comprise a hole (e.g., the hole has an inner perimeter that is part of the central region 432) with the coupling portion 420 extending from the fixture 418 along a longitudinal axis 422 through the hole, and the coupling portion 420 can be mechanically coupled by the at least one resilient coupler 450 to the surrounding central region 432. The peripheral portion 434 of the piezoelectric oscillator 430 of certain such implementations (see, e.g., FIG. 2A) is affixed to the at least one mass 440 by at least one bonding element 442 (e.g., adhesive; epoxy; spring; weld; rivet; screw; screw threads).

In certain implementations, as schematically illustrated by FIG. 2B, the peripheral portion 434 of the piezoelectric oscillator 430 is mechanically coupled to the at least one mass 440 by the at least one resilient coupler 450′ and the peripheral portion 434 does not substantially move relative to the at least one mass 440 during the bending oscillations 436 of the piezoelectric oscillator 430. For example, the peripheral portion 434 can comprise at least a portion of an outer perimeter of the piezoelectric oscillator 430, and the peripheral portion 434 can be mechanically coupled by the at least one resilient coupler 450′ to the at least one mass 440. The central portion 432 of the piezoelectric oscillator 430 of certain such implementations (see, e.g., FIG. 2B) is affixed to the coupling portion 420 by at least one bonding element 444 (e.g., adhesive; epoxy; spring; weld; rivet; screw; screw threads).

In certain implementations, the at least one mass 440 comprises one or more materials having sufficiently large mass density and dimensions (e.g., length; width; thickness; volume) such that the at least one mass 400 has a mass (e.g., weight) configured to achieve a predetermined resonant frequency for the bending oscillations 436 (e.g., the generated vibrations) (e.g., in a range of 250 Hz to 3 kHz; about 750 Hz). Examples of such materials of the at least one mass 440 include but are not limited to: tungsten; tungsten alloy; osmium; osmium alloy. The at least one mass 440 can comprise a unitary (e.g., single; monolithic) component, multiple components (e.g., two or more sub-masses) that are affixed to one another, and/or multiple components that are separate from one another. In certain implementations, the at least one mass 440 comprises separate masses 440 positioned at separate locations at the peripheral portion 434 of the piezoelectric oscillator 430. For example, the at least one mass 440 can comprise two separate masses 440 positioned at opposite ends of a substantially rectangular piezoelectric oscillator 430, the ends spaced from the coupling portion 420. In certain other implementations, the at least one mass 440 extends substantially completely around a perimeter of the piezoelectric oscillator 430. For example, the at least one mass 440 can be substantially circular and positioned at and concentrically around a perimeter of a disk-shaped piezoelectric oscillator 430.

In certain implementations, the peripheral portion 434 of the piezoelectric oscillator 430 is configured to substantially move relative to the coupling portion 420 during the bending oscillations 436 of the piezoelectric oscillator 430 (e.g., in response to time-varying electrical voltage signals applied across portions of the piezoelectric oscillator 430). For example, the bending oscillations 436 can move the peripheral portion 434 and the at least one mass 440 along a direction substantially parallel to the longitudinal axis 422 of the coupling portion 420 (e.g., substantially perpendicular to the piezoelectric oscillator 430). By changing shape in response to received time-varying electrical voltage signals (e.g., oscillating positive and negative voltages across at least a portion of the piezoelectric oscillator 430), the piezoelectric oscillator 430 can generate vibrational energy and the at least one mass 440 moves (e.g., oscillates; vibrates) relative to the coupling portion 420 (e.g., along a direction substantially parallel to the longitudinal axis 422 of the coupling portion 420).

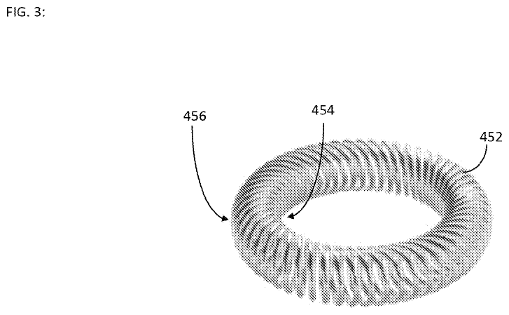

In certain implementations, the at least one resilient coupler 450, 450′ comprises at least one resilient element 452. Examples of resilient elements 452 compatible with certain implementations described herein include springs (e.g., garter spring; radial spring) and/or O-rings comprising a resilient material (e.g., silicone; elastomer; rubber; Viton™ fluoroelastomer). FIG. 3 schematically illustrates an example resilient element 452 comprising a garter spring compatible with certain implementations described herein (see, e.g., FIGS. 2A-2B). The resilient element 452 of FIG. 3 has an inner perimeter 454 and an outer perimeter 456. The at least one resilient element 452 can comprise various shapes, dimensions, and materials compatible with the various implementations described herein.

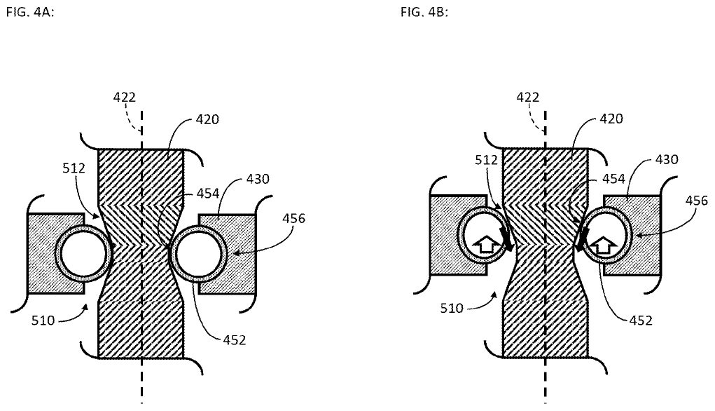

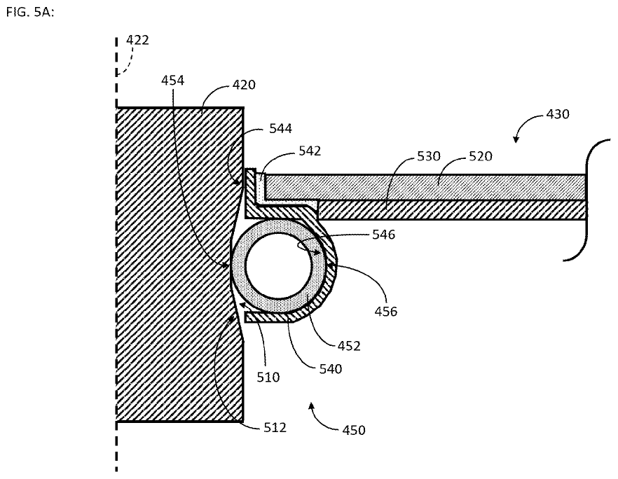

FIG. 4A-4B schematically illustrate cross-sectional views of two configurations of an example resilient coupler 450 comprising a resilient element 452 in accordance with certain implementations described herein. In certain implementations, as schematically illustrated by FIG. 4A, the outer perimeter 456 of the resilient element 452 is affixed to a portion of the apparatus 400 and the inner perimeter 454 of the resilient element 452 is in slidable contact with a recess 510 (e.g., groove) of another portion of the apparatus 400 (e.g., an outer surface of the coupler portion 420 as shown in FIG. 2A). For example, as shown in FIG. 2A, the outer perimeter 456 can be rigidly affixed to the piezoelectric oscillator 430 and the inner perimeter 454 can be in slidable contact with the recess 510 of an outer surface of the coupler portion 420. For another example, the outer perimeter 456 can be affixed to the at least one mass 440 and the inner perimeter 454 can be in slidable contact with the recess 510 of the peripheral portion 434 of the piezoelectric oscillator 430.

The recess 510 of certain implementations comprises curved or slanted surfaces 512 (e.g., non-parallel to the longitudinal axis 422) such that (i) the resilient element 452 is at an equilibrium position within the recess 510 in the absence of an external force (e.g., impulse) greater than a predetermined value being applied to the apparatus 400 (e.g., in an operational state of the apparatus 400; schematically illustrated by FIG. 4A) and (ii) the resilient element 452 is in a non-equilibrium position within the recess 510 upon an external force (e.g., impulse) greater than the predetermined value being applied to the apparatus 400 (e.g., in a non-operational state of the apparatus 400; the resilient element 452 partially decoupled from the coupling portion 420; schematically illustrated by FIG. 4B). The strength of the at least one resilient coupler 450 (e.g., in conjunction with other physical parameters of the apparatus 410, such as the size and shape of the recess 510 and surfaces 512) can be designed to allow the partial decoupling of the resilient element 452 to occur at a selected predetermined value of the external force. The external force of certain implementations is higher than a maximum working force of the piezoelectric oscillator 430 (e.g., a maximum working force of 1.2 N) and lower than a minimum force that gives rise to a stress and/or strain sufficient to break the piezoelectric oscillator 430. For example, upon an external force of sufficient magnitude and direction being applied to the coupling portion 420 of the actuator 410 (e.g., at least 1.5 N; at least 2 N; at least 3 N), the resilient element 452 can temporarily partially decouple from the coupling portion 420 such that the position of the resilient element 452 relative to the coupling portion 420 changes (e.g., due to inertia; denoted in FIG. 4B by two white arrows) from the equilibrium position to a non-equilibrium position. The resilient element 452 remains at least partially coupled to the coupling portion 420 (e.g., in contact with the surfaces 512) while in the non-equilibrium position. In certain implementations, as shown in FIGS. 4A-4B, the interaction of the resilient element 452 with the surfaces 512 of the recess 510 resiliently deforms the resilient element 452 (e.g., radially expands the inner perimeter 454) to generate at least one restoring force (denoted in FIG. 4B by two dark arrows) that direct the resilient element 452 back to the equilibrium position. After the external force is no longer applied to the actuator 410, the resilient element 452 returns to the equilibrium position, and the actuator 410 can resume normal operation.

In certain other implementations, the inner perimeter 454 of the resilient element 452 is affixed to a portion of the apparatus 400 (e.g., the coupling portion 420) and the outer perimeter 456 of the resilient element 452 is in slidable contact with a recess 510 of another portion of the apparatus (e.g., the piezoelectric oscillator 430). For example, as schematically illustrated FIG. 2B, the inner perimeter 454 of the resilient element 452 of the resilient coupler 450′ is affixed to the piezoelectric oscillator 430 and the outer perimeter 456 of the resilient element 452 of the resilient coupler 450′ is in slidable contact with a recess 510 of the at least one mass 440. In certain such implementations, the interaction of the resilient element 452 with the curved or slanted surfaces 512 of the recess 510 can deform the resilient element 452 (e.g., radially compress the outer perimeter 456) to generate the restoring forces that interact with the curved or slanted surfaces 512 to direct the resilient element 452 back to the equilibrium position.

In certain implementations, the at least one resilient coupler 450, 450′ substantially dampens (e.g., prevents; avoids) stresses and/or strains being applied across the piezoelectric oscillator 430 that could otherwise cause failure (e.g., breakage) of the piezoelectric oscillator 430. By avoiding having the piezoelectric oscillator 430 rigidly affixed to both the coupling portion 420 and the at least one mass 440, certain implementations described herein allow the at least one resilient coupler 450, 450′ to temporarily partially decouple the piezoelectric oscillator 430 from the coupling portion 420 and/or the at least one mass 440 (e.g., allowing relative motion along the longitudinal axis 422), thereby dampening (e.g., preventing; avoiding) excessive bending of the piezoelectric oscillator 430 due to the inertia of the at least one mass 440. The at least one resilient coupler 450, 450′ is further configured to generate a restoring force to recouple the piezoelectric oscillator 430 to the coupling portion 420 and/or the at least one mass 440.

In certain implementations, the actuator 410 further comprises one or more surfaces (e.g., components of the housing) that are configured to halt the motion of the at least one mass 440 relative to the coupling portion 420 resulting from the external impulse. For example, the actuator 410 can comprise a mechanical stop comprising one or more silicone pads (e.g., above and/or below the at least one mass 440) which the at least one mass 440 does not contact during normal operation of the actuator 410. However, in response to the external impulse being applied to the actuator 410, the at least one mass 440 moves in a direction substantially parallel to the longitudinal axis 422 to contact the silicone pads, which thereby limit the maximum deflection of the at least one mass 440 due to the external impulse. The maximum deflection is insufficient to create stresses within the piezoelectric oscillator 430 sufficient to break the piezoelectric oscillator 430. In certain implementations in which the piezoelectric oscillator 430 and the at least one resilient coupler 450, 450′ have relatively small mass and inertia as compared to the at least one mass 440, the stoppage of the motion of the at least one mass 440 by the silicone pads does not impart significant stresses to the piezoelectric oscillator 430.

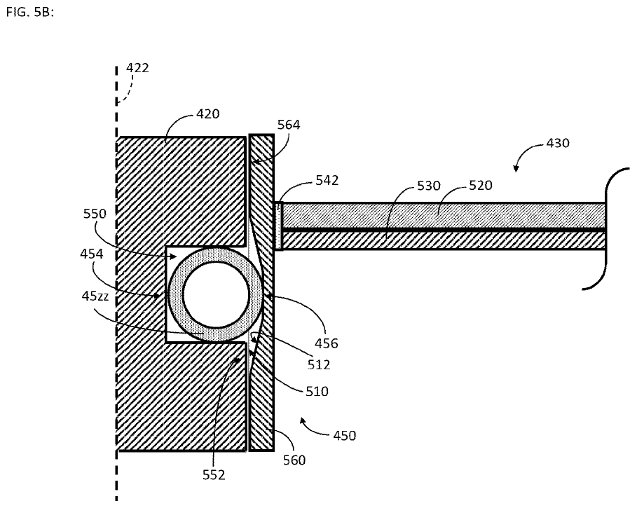

FIGS. 5A-5B schematically illustrate cross-sectional views of portions of two example resilient couplers 450 in accordance with certain implementations described herein. Each of the full resilient couplers 450 of FIGS. 5A and 5B can be symmetric (e.g., circularly symmetric) about the longitudinal axis 422 of the coupling portion 420 and FIGS. 5A-5B show the portion of the example resilient couplers 450 on one side of the longitudinal axis 422. The piezoelectric oscillator 430 of FIGS. 5A and 5B comprises an active portion 520 comprising the at least one piezoelectric material and a passive portion 530 that does not comprise a piezoelectric material (e.g., metal; steel; spring steel; aluminum; a backplate) and that is affixed to a bottom surface of the active portion 520. A portion of the resilient coupler 450 is rigidly affixed (e.g., by epoxy 542) to both the active portion 520 and the passive portion 530 and is configured to move with the piezoelectric oscillator 430 relative to the coupling portion 420 in a direction substantially parallel to the longitudinal axis 422 in response to a sufficiently strong impulse applied to the actuator 410. In addition, as described above with regard to FIGS. 4A-4B, the resilient element 452 is configured to generate a restoring force to move the piezoelectric oscillator 430 back to the equilibrium position after the impulse has been applied.

As schematically illustrated by FIG. 5A, the portion of the resilient coupler 450 rigidly affixed to the piezoelectric oscillator 430 comprises a receptacle 540 (e.g., clip; clamp) comprising at least one surface 544 configured to slide along an outer surface of the coupling portion 420 in a direction substantially parallel to the longitudinal axis 422 and an inner surface 546 configured to contact the resilient element 452 (e.g., at least the outer diameter 456). The receptacle 540 is configured to receive and hold (e.g., affixed to) the resilient element 452 such that the inner perimeter 454 of the resilient element 452 is in slidable contact with the coupling portion 420 at the equilibrium location within the recess 510. As the receptacle 540 moves relative to the coupling portion 420, the resilient element 452 is deformed (e.g., compressed) by the curved or slanted surfaces 512 to generate the restoring force.

As schematically illustrated by FIG. 5B, the coupling portion 420 comprises a channel 550 (e.g., groove) in an outer surface 552 of the coupling portion 420, the channel 550 sized to receive and hold (e.g., be affixed to) the resilient element 452 with the inner perimeter 454 of the resilient element 452 within the channel 550 and the outer perimeter 456 of the resilient element 452 extending radially past the outer surface 552 surrounding the channel 550. The portion of the resilient coupler 450 affixed to the piezoelectric oscillator 430 of FIG. 5B comprises a cylinder 560 (e.g., rigid tube) configured to surround at least a portion of the coupling portion 420 (e.g., having a longitudinal axis that is colinear with the longitudinal axis 422 of the coupling portion 420) and having an inner surface 564 in slidable contact with the coupling portion 420. The cylinder 560 comprises a recess 510 having curved or slanted surfaces 512 in an inner surface of the tube 560. As the cylinder 560 moves relative to the coupling portion 420 in response to an external impulse applied to the actuator 410, the resilient element 452 is deformed (e.g., compressed) by the curved or slanted surfaces 512 to generate the restoring force.

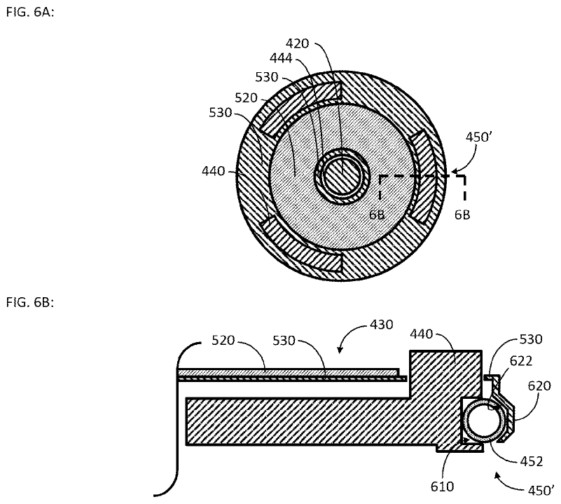

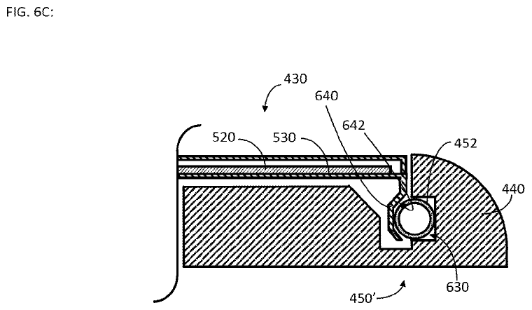

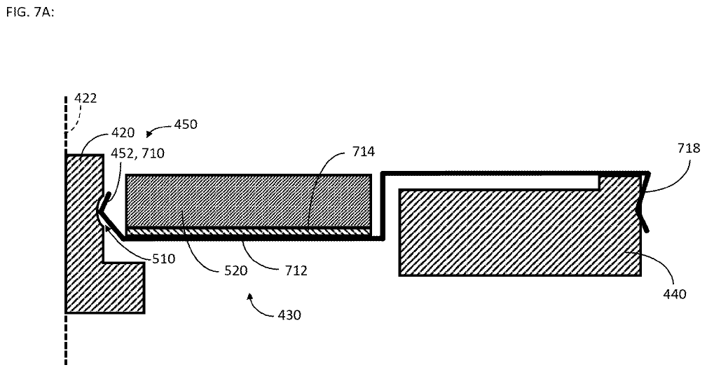

FIG. 6A schematically illustrates a top view of an example actuator 410 comprising a resilient coupler 450′ that releasably couples the piezoelectric element 430 with the at least one mass 440 in accordance with certain implementations described herein, and FIG. 6B schematically illustrates a cross-sectional view of a portion of the example actuator 410 of FIG. 6A. The piezoelectric oscillator 430 of FIGS. 6A and 6B is substantially circular and comprises an active portion 520 comprising the at least one piezoelectric material and a passive portion 530 that does not comprise a piezoelectric material (e.g., metal; steel; spring steel; aluminum; a backplate) and that is affixed to a bottom surface of the active portion 520. The passive portion 530 is rigidly affixed to the coupling portion 420 by at least one bonding element 444. The at least one resilient coupler 450′ comprises a resilient element 452 within a channel 610 (e.g., groove) in an outer surface of the at least one mass 440, the channel 610 sized to receive and hold the resilient element 452 with the inner perimeter 454 of the resilient element 452 within the channel 610 and the outer perimeter 456 of the resilient element 452 extending radially past the outer surface of the at least one mass 440. The passive portion 530 further comprises a receptacle 620 (e.g., clip; clamp) configured to be snap-coupled (e.g., press-fitted) to the resilient element 452 and having curved or slanted inner surfaces 622. As the receptacle 620 moves relative to the at least one mass 440 in response to an external impulse applied to the actuator 410, the resilient element 452 is deformed (e.g., compressed) by the curved or slanted surfaces 622 to generate the restoring force.

FIG. 6C schematically illustrates a cross-sectional view of a portion of another example actuator 410 comprising a resilient coupler 450′ that releasably couples the piezoelectric element 430 with the at least one mass 440 in accordance with certain implementations described herein. The at least one resilient coupler 450′ of FIG. 6C comprises a resilient element 452 within a channel 630 (e.g., groove) in an inner surface of the at least one mass 440, the channel 630 sized to receive and hold the resilient element 452 with the outer perimeter 456 of the resilient element 452 within the channel 630 and the inner perimeter 454 of the resilient element 452 extending radially past the inner surface of the at least one mass 440. The passive portion 530 further comprises a receptacle 640 (e.g., clip; clamp) configured to be snap-coupled (e.g., press-fitted) to the resilient element 452 and having curved or slanted inner surfaces 642. As the at least one mass 440 moves relative to the receptacle 640 in response to an external impulse applied to the actuator 410, the resilient element 452 is deformed (e.g., compressed) by the curved or slanted surfaces 642 to generate the restoring force.

FIGS. 6B and 6C schematically illustrate example resilient couplers 450′ in which the at least one mass 440 comprises the channel 610, 630 that receives and holds the resilient element 452 and the piezoelectric oscillator 430 is rigidly affixed to the receptacle 620, 640 having the curved or slanted surfaces 622, 642 along with the resilient element 452 is slidably coupled. Certain other implementations have resilient couplers 450′ in which the piezoelectric oscillator 430 is rigidly affixed to a channel that receives and holds the resilient element 452 and the at least one mass 440 comprises the curved or slanted surfaces along which the resilient element 452 is slidably coupled.

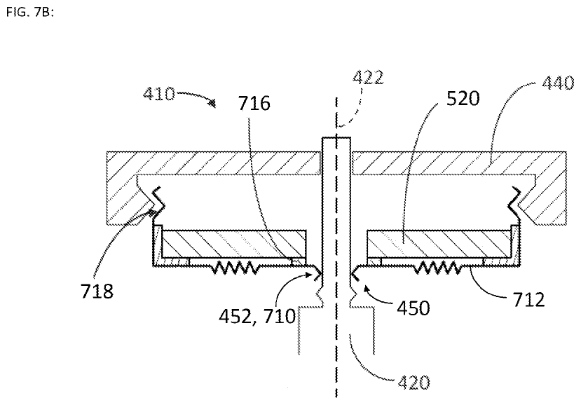

FIGS. 7A and 7B schematically illustrate cross-sectional views of two example actuators 410 in which the resilient element 452 of the at least one resilient coupler 450 comprises a spring 710 in accordance with certain implementations described herein (with FIG. 7A showing the portion of the example actuator 410 on one side of the longitudinal axis 422). As shown in FIGS. 7A-7B, the spring 710 can be a portion of a backplate 712 (e.g., comprising metal; steel; aluminum) affixed to an active element 520 of the piezoelectric oscillator 430. In certain implementations, the example actuators 410 of FIG. 7A-7B are substantially cylindrically symmetric about the longitudinal axis 422 of the coupling portion 420 (e.g., the active element 520 is disk-shaped). The backplate 712 is sufficiently flexible so as to bend in response to expansion and/or contraction of the active portion 520 in a radial direction relative to the longitudinal axis 422. As a result of the bending, the at least one mass 440 moves in a direction substantially parallel to the longitudinal axis 422. As shown in FIG. 7A, the piezoelectric oscillator 430 can further comprise a flexible material 714 (e.g., silicone) configured to affix the active portion 520 with the backplate 710, and the flexible material 714 can provide vibration damping to tailor the vibrational frequency distribution of the actuator 410. As shown in FIG. 7B, the piezoelectric oscillator 430 can comprise a rigid material 716 (e.g., epoxy) configured to affix the active portion 520 with the flexible backplate 712 (denoted in FIG. 7B as having a zigzag cross-sectional structure). Similarly to the resilient element 452 of FIGS. 2A, 4A-4B, and 5A, the spring 710 of FIGS. 7A-7B is in slidable contact with a recess 510 (e.g., groove) of an outer surface of the coupler portion 420 (the recess 510 is not shown in FIG. 7B). The backplate 710 can further comprise a spring portion 718 configured to be snap-coupled with the at least one mass 440.

In certain implementations, the at least one resilient coupler 450, 450′ as described herein provides the actuator 410 with an increased tolerance to impulses from shocks or impacts as compared to other actuators with only rigid connections of a piezoelectric oscillator with both a center post and the counterweight. By partially decoupling upon a threshold external force (e.g., at least 1.5 N; at least 2 N; at least 3 N) being applied to the actuator 410, the at least one resilient coupler 450, 450′ can dampen (e.g., prevent; avoid) excessive stresses and/or strains from being applied to the piezoelectric oscillator 430 that could otherwise damage (e.g., break) the piezoelectric oscillator 430.

In certain implementations, the at least one resilient coupler 450, 450′ is configured to be snap-coupled onto the coupling portion 420 and/or the at least one mass 440. By virtue of being snap-coupled onto other portions of the actuator 410, the at least one resilient coupler 450, 450′ of certain implementations described herein allows for pre-mounting testing of the piezoelectric/counterweight assembly (e.g., on a test interface or skull simulator). Once the assembly is approved for use, the assembly can be removed and placed onto the actual implantable device. This ability to test the piezoelectric/counterweight assembly can result in improved yields as compared to assemblies which can only be operated once welded together.

In certain implementations, the mechanical coupling strength of the at least one resilient coupler 450, 450′, in conjunction with one or more other physical parameters of the actuator 410, can be tailored to adjust (e.g., controllably tune) the resonant frequency and/or the vibrational frequency spectrum of the actuator 410 for the bending oscillations generated during operation. For example, the resonant frequency of the actuator 410 can be set to be less than 650 Hz (e.g., in a range of 550 Hz to 600 Hz). For another example, the vibrational frequency spectrum of the actuator 410 can be set to reduce (e.g., dampen; prevent) unwanted resonances in a predetermined frequency range (e.g., from 6 kHz to 9 kHz) and/or to boost responsiveness in a mid-frequency regime (e.g., within 100 Hz of the resonant frequency).

In certain implementations, the at least one resilient coupler 450, 450′ is configured to reduce the number of parts that the actuator 410 comprises by simplifying the coupling between the piezoelectric oscillator 430 and at least one of the coupling portion 420 and the at least one mass 440. In certain implementations, the at least one resilient coupler 450, 450′ is configured to reduce (e.g., prevent; avoid) unwanted tilting of the piezoelectric oscillator 430 from an orientation in which the piezoelectric oscillator 430 extends substantially perpendicularly to the longitudinal axis 422).

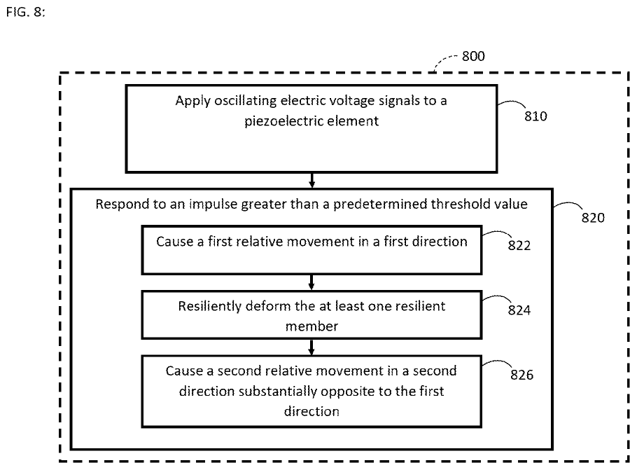

FIG. 8 is a flow diagram of an example method 800 in accordance with certain implementations described herein. In an operational block 810, the method 800 comprises applying oscillating electric voltage signals to a piezoelectric element (e.g., active portion 520 of a piezoelectric oscillator 430) mechanically coupled to a rigid portion by a first coupler and to at least one counterweight (e.g., at least one mass 440) by a second coupler. At least one of the first coupler and the second coupler comprises at least one resilient member (e.g., resilient element 452). The piezoelectric element is responsive to the electrical voltage signals by imparting oscillatory motion to the at least one counterweight relative to the rigid portion. For example, the rigid portion (e.g., coupling portion 420) can be rigidly affixed to a fixture implanted on or within a recipient's body, and the rigid portion and the fixture can be configured to transmit vibrational energy from the piezoelectric element to the recipient's body. The piezoelectric element can be substantially planar (e.g., disk-shaped; circular; rectangular) and can extend substantially perpendicularly to a longitudinal axis of the rigid portion.

In an operational block 820, the method 800 further comprises responding to an impulse greater than a predetermined threshold value applied to at least one of the rigid portion, the piezoelectric element, and the at least one counterweight. For example, the impulse can be applied to a housing containing the rigid portion, the piezoelectric element, and the at least one counterweight, and can be the result of a mechanical shock or impact to the housing.

In an operational block 822, said responding to the impulse comprises causing a first relative movement between the piezoelectric element and the rigid portion and/or between the piezoelectric element and the at least one counterweight, the first relative movement in a first direction. For example, the relative movement can be from an equilibrium position to a non-equilibrium position, and the first direction can be substantially parallel to the longitudinal axis of the rigid portion.

In an operational block 824, said responding to the impulse further comprises, in response to the relative movement, resiliently deforming the at least one resilient member to apply at least one restoring force to at least one of the rigid portion, the piezoelectric element, and the at least one counterweight. For example, the resilient member can be radially expanded (e.g., an inner perimeter of the resilient member increases) and/or radially compressed (e.g., an outer perimeter of the resilient member decreases). Deforming the at least one resilient member can comprise sliding the at least one resilient member along at least one curved or slanted surface in contact with the at least one resilient member.

In an operational block 826, said responding to the impulse further comprises, in response to the at least one restoring force, causing a second relative movement between the piezoelectric element and the rigid portion and/or between the piezoelectric element and the at least one counterweight, the second relative movement in a second direction substantially opposite to the first direction. For example, the at least one restoring force can act on the at least one resilient member to return the at least one resilient member to the equilibrium position.

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as, among others, “can,” “could,” “might,” or “may,” unless specifically stated otherwise, or otherwise understood within the context as used, is generally intended to convey that certain implementations include, while other implementations do not include, certain features, elements and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

It is to be appreciated that the implementations disclosed herein are not mutually exclusive and may be combined with one another in various arrangements. In addition, although the disclosed methods and apparatuses have largely been described in the context of conventional cochlear implants, various implementations described herein can be incorporated in a variety of other suitable devices, methods, and contexts. More generally, as can be appreciated, certain implementations described herein can be used in a variety of implantable medical device contexts that can benefit from having at least a portion of the received power available for use by the implanted device during time periods in which the at least one power storage device of the implanted device unable to provide electrical power for operation of the implantable medical device.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

While the methods and systems are discussed herein in terms of elements labeled by ordinal adjectives (e.g., first, second, etc.), the ordinal adjective are used merely as labels to distinguish one element from another (e.g., one signal from another or one circuit from one another), and the ordinal adjective is not used to denote an order of these elements or of their use.

The invention described and claimed herein is not to be limited in scope by the specific example implementations herein disclosed, since these implementations are intended as illustrations, and not limitations, of several aspects of the invention. Any equivalent implementations are intended to be within the scope of this invention. Indeed, various modifications of the invention in form and detail, in addition to those shown and described herein, will become apparent to those skilled in the art from the foregoing description. Such modifications are also intended to fall within the scope of the claims. The breadth and scope of the invention should not be limited by any of the example implementations disclosed herein, but should be defined only in accordance with the claims and their equivalents.

1. An apparatus comprising:
an actuator configured to generate vibrations, the actuator comprising:
a coupling portion configured to be in mechanical communication with a fixture implanted on or within a recipient's body, the coupling portion extending from the fixture along a longitudinal axis;
a piezoelectric oscillator having a first portion in mechanical communication with the coupling portion and a second portion spaced from the coupling portion, the piezoelectric oscillator configured to undergo bending oscillations in response to received electric voltage signals;
at least one mass in mechanical communication with the second portion, the at least one mass configured to move in response to the bending oscillations of the piezoelectric oscillator; and
at least one resilient coupler mechanically attached to the coupling portion and to the first portion and/or mechanically attached to the second portion and to the at least one mass, the at least one resilient coupler configured to, in response to an impulse applied to the actuator, allow movement of the first portion relative to the coupling portion and/or of the at least one mass relative to the second portion, the movement substantially parallel to the longitudinal axis.

2. The apparatus of claim 1, wherein the at least one resilient coupler comprises a garter spring or an O-ring.

3. The apparatus of claim 1, wherein the coupling portion comprises an outer surface having a recess with surface portions that are non-parallel to the longitudinal axis, at least a portion of the at least one resilient coupler rigidly affixed to the piezoelectric oscillator and comprising a resilient element in slidable contact with the coupling portion at an equilibrium location within the recess.

4. The apparatus of claim 1, wherein at least a portion of the at least one resilient coupler is rigidly affixed to the piezoelectric oscillator and comprises an inner surface having a recess with surface portions that are non-parallel to the longitudinal axis, the at least one resilient coupler comprising a resilient element received in a channel of the coupling portion and in slidable contact with the surface portions of the recess at an equilibrium location within the recess.

5. The apparatus of claim 1, wherein at least a portion of the at least one resilient coupler rigidly affixed to the piezoelectric oscillator and comprises an inner surface having a recess with surface portions that are non-parallel to the longitudinal axis, the at least one resilient coupler comprising a resilient element received in a channel of the at least one mass and in slidable contact with the surface portions of the recess at an equilibrium location within the recess.

6. The apparatus of claim 1, wherein at least a portion of the at least one resilient coupler rigidly affixed to the piezoelectric oscillator and comprises an outer surface having a recess with surface portions that are non-parallel to the longitudinal axis, the at least one resilient coupler comprising a resilient element received in a channel of the at least one mass and in slidable contact with the surface portions of the recess at an equilibrium location within the recess.

7. The apparatus of claim 1, wherein the at least one mass comprises a surface having a recess with surface portions that are non-parallel to the longitudinal axis, at least a portion of the at least one resilient coupler rigidly affixed to the piezoelectric oscillator and comprising a resilient element in slidable contact with the at least one mass at an equilibrium location within the recess.

8. The apparatus of claim 3, wherein the surface portions and the resilient element are configured to, in response to the impulse, move relative to one another in a first direction substantially parallel to the longitudinal axis such that the resilient element is resiliently deformed by the surface portions and generates at least one restoring force configured to move the surface portions and the resilient element relative to one another in a second direction opposite to the first direction.

9. The apparatus of claim 1, wherein the piezoelectric oscillator extends along a plane substantially perpendicular to the longitudinal axis, the first portion comprises an inner perimeter of a hole extending through the piezoelectric oscillator through which the coupling portion extends, and the second portion comprises an outer perimeter of the piezoelectric oscillator.

10. The apparatus of claim 1, wherein the actuator is configured to be implanted on or within the recipient's body, the fixture configured to transmit the vibrations to the recipient's body such that the vibrations evoke a hearing percept by the recipient.

11. The apparatus of claim 1, further comprising a housing configured to hermetically seal the piezoelectric oscillator, the at least one resilient coupler, and the at least one mass from an environment surrounding the actuator.

12. A method comprising:
applying oscillating electric voltage signals to a piezoelectric element mechanically coupled to a rigid portion by a first coupler and to at least one mass by a second coupler, at least one of the first coupler and the second coupler comprising a resilient member, the piezoelectric element responding to the electric voltage signals by imparting oscillatory motion to the at least one mass relative to the rigid portion; and
in response to an impulse greater than a predetermined threshold value applied to at least one of the coupling portion, the piezoelectric element, and the at least one mass:
causing a first relative movement between the piezoelectric element and the rigid portion and/or between the piezoelectric element and the at least one mass, the first relative movement in a first direction;
in response to the relative movement, resiliently deforming the at least one resilient member to apply at least one restoring force to at least one of the coupling portion, the piezoelectric element, and the at least one mass; and
in response to the at least one restoring force, causing a second relative movement between the piezoelectric element and the rigid portion and/or between the piezoelectric element and the at least one mass, the second relative movement in a second direction substantially opposite to the first direction.

13. The method of claim 12, wherein the rigid portion is rigidly affixed to a fixture implanted on or within a recipient's body, the rigid portion and the fixture configured to transmit vibrational energy from the piezoelectric element to the recipient's body.

14. The method of claim 12, wherein the piezoelectric element is planar and extends substantially perpendicularly to a longitudinal axis of the rigid portion.

15. The method of claim 12, wherein the impulse a mechanical shock or impact to a housing containing the rigid portion, the piezoelectric element, and the at least one counterweight.

16. The method of claim 12, wherein resiliently deforming the at least one resilient member comprises radially expanding the at least one resilient member and/or radially compressing the at least one resilient member.

17. The method of claim 12, wherein resiliently deforming the at least one resilient member comprises sliding the at least one resilient member along at least one curved or slanted surface in contact with the at least one resilient member.

18. The method of claim 12, wherein the relative movement is from an equilibrium position to a non-equilibrium position, and the at least one restoring force acts on the at least one resilient member to return the at least one resilient member to the equilibrium position.

19. The method of claim 12, further comprising halting the first relative movement by contacting the at least one counterweight with a mechanical stop.

20. An apparatus comprising:
an auditory prosthesis configured to generate and transmit vibrations to a recipient's body such that the vibrations evoke a hearing percept by the recipient, the auditory prosthesis comprising:
an elongate structure configured to be in mechanical communication with a bone fixture implanted on or within a recipient's body;
a piezoelectric oscillator in mechanical communication with the elongate structure, the piezoelectric oscillator configured to undergo bending oscillations in response to received electric voltage signals;
at least one counterweight in mechanical communication with the piezoelectric oscillator, the at least one counterweight configured to move in response to the bending oscillations of the piezoelectric oscillator; and
at least one coupler comprising a resilient spring or material, the at least one coupler mechanically coupling the elongate structure with the piezoelectric oscillator and/or mechanically coupling the piezoelectric oscillator with the at least one counterweight, the at least one coupler at a first position relative to the elongate structure and configured to move to at least one second position relative to the elongate structure in response to an external force applied to the auditory prosthesis greater than a predetermined threshold value, the at least one coupler further configured to then return to the first position upon absence of the external force.

21. The apparatus of claim 20, wherein the abutment screw extends from the bone fixture along a longitudinal axis and the at least one coupler responds to the external force by moving along the elongate structure in a direction substantially parallel to the longitudinal axis.

22. The apparatus of claim 20, wherein the resilient spring comprises a garter spring or an O-ring.
